(19) United States
(12) Patent Application Publication
(10) Pub. No.: US 2026/0243024 A1
(43) Pub. Date: Aug. 20, 2026

(54) DUAL EMULSIFICATION OF ALKENYL SUCCINIC ANHYDRIDE TO IMPROVE SIZING PERFORMANCE AND STABILITY

(71) Applicant: KEMIRA OYJ, HELSINKI (FI)

(72) Inventors: Jennifer RISER, Atlanta, GA (US); Christopher LEWIS, Atlanta, GA (US)

(21) Appl. No.: 19/470,852

(22) PCT Filed: Mar. 28, 2024
(86) PCT No.: PCT/US2024/021947

§ 371 Date: Sep. 30, 2025

Related U.S. Application Data
(60) Provisional application No. 63/456,265, filed on Mar. 31, 2023.

(30) Foreign Application Priority Data
Sep. 20, 2023 (FI) 20236040

(51) Int. Cl. D21H 17/15; D21H 17/29; D21H 17/45; D21H 21/16

(52) U.S. Cl. CPC D21H 17/15; D21H 17/29; D21H 17/45; D21H 21/16

(57) ABSTRACT

The present invention relates to compositions and methods for preparation of stable alkenyl succinic anhydride (ASA) sizing emulsions which potentially may be used in the manufacturing of paper and board. In particular, the disclosure provides methods for dual emulsification of ASA using a cationic polymer as the primary emulsification agent and cationic starch as the secondary emulsification agent which provides for considerable reduction in overall starch utilization compared to conventional natural polymer ASA emulsification applications. The present invention also relates to processes for producing high ash paper and board using these ASA sizing emulsions.

### RELATED APPLICATIONS

The present application claims benefit of priority to U.S. Provisional Application No. 63/456,265, filed on Mar. 31, 2023, and to Finnish Application Number 20236040 filed on Sep. 20, 2023, the contents of both of which are incorporated by reference in their entireties.

### FIELD OF THE INVENTION

The present invention generally relates to compositions and methods for preparation of an alkenyl succinic anhydride (ASA) sizing emulsion for use in manufacturing of paper and board. In particular, the disclosure provides methods for dual emulsification of ASA using a cationic polymer as the primary emulsification agent and cationic starch as the secondary emulsification agent to impart superior stability to the emulsion and enhance sizing performance in wood-free papermaking systems often containing high ash, at considerable reduction in overall starch utilization compared to conventional natural polymer ASA emulsification applications.

### BACKGROUND OF THE INVENTION

In papermaking and paper finishing, a sizing agent is often employed to provide desirable characteristics sought in the ultimate paper product. Sizing, or sizing property, is a measure of the resistance of a manufactured paper or paperboard product to the penetration or wetting by an aqueous liquid, water, or ink.

Sizing agents are generally internal additives employed during papermaking or external surface additives employed on the finished sheet or web that increase this resistance. Sizing agents may be various substances that are used to facilitate the liquid resistance, which can include but is not limited to water, ink, or other media, as protection for a paper surface. These substances are typically used to prevent fluids from absorbing into the paper.

Alkenyl succinic anhydride (ASA) is a common internal sizing agent for papermaking. ASA sizing agents tend to be hydrophobic, and they generally must be used in aqueous paper manufacturing systems.

ASA is typically emulsified in a natural polymer, typically modified cationic starch, or a synthetic cationic polymer before it is introduced to the wet end of the paper machine. Because emulsions of ASA made with either natural polymer or synthetic polymer are not stable, they are typically created on mill site in situ with equipment that provides sufficient shear to create an effective emulsion to be applied directly to the machine or within a few hours of manufacture. Although there are clear benefits of (high) starch use for the emulsification of ASA with respect to emulsion quality, sizing retention and overall sizing efficiency, high use of starch in the wet end of the paper process will increase the water retention of the paper web with increasing starch levels. and will conversely reduce the paper web water retention with decreasing wet end starch levels. Higher water retention decreases the pressing efficiency of the paper web, reducing solids of the web exiting the press section. This will increase the drying energy demand of the sheet and can decrease productivity and overall paper machine runnability.

Considerable effort is required to achieve a uniform, stable ASA emulsion suitable for paper manufacture. Water chemistry of the process along with the various furnish components can adversely impact the efficiency of ASA sizing. Synthetic polymer-emulsified ASA efficiency is often impractical for this reason, when applied singularly, in furnishes with significant ash levels often observed in alkaline printing and writing grades and some packaging grades where calcium carbonate pigments and various kaolin pigments are utilized, or when there is a significant level of free calcium ion present in the wet end. Generally, [Ca++]>150 ppm as calcium or 400 ppm as calcium carbonate are considered high.

Presently, the availability of starch for commercial applications is severely limited, due to supply chain shortages. The present invention seeks to utilize a dual emulsification technique using a cationic solution polymer in the primary emulsification step, followed by secondary emulsification in starch at low dose under shear. The present invention also seeks to form low starch ASA sizing emulsion suitable for use in high ash furnish for preparation of ink and water resistant writing and printing grade paper and board. The dual emulsification imparts superior stability to the emulsion and enhances sizing performance in high ash papermaking, at considerable reduction in overall starch utilization compared to conventional natural polymer ASA emulsification applications.

### SUMMARY OF THE INVENTION

The present invention generally relates to compositions and methods for preparation of an alkenyl succinic anhydride (ASA) sizing emulsion for use in manufacturing of paper and board. In particular, the disclosure provides methods for dual emulsification of ASA using a cationic polymer as the primary emulsification agent and cationic starch as the secondary emulsification agent to impart superior stability to the emulsion and enhance sizing performance in high ash papermaking, at considerable reduction in overall starch utilization compared to conventional natural polymer ASA emulsification applications.

In one aspect, the present invention provides a method for preparation of a stable alkenyl succinic anhydride (ASA) sizing emulsion which is suitable for use in manufacturing of paper and board, the method comprising:
(a) obtaining or producing an alkenyl succinic anhydride (ASA) sizing agent;
(b) combining said ASA sizing agent with a primary emulsifying agent and emulsifying to form a primary emulsion; and
(c) after step (b) adding a secondary emulsifying agent and emulsifying to form said ASA sizing emulsion, and
(d) optionally, after steps (a) to (c) adding the resultant stable ASA sizing emulsion to a papermaking furnish, pulp, or fiber stock, optionally a high ash furnish.

In some exemplary embodiments the method further comprises, after step (c):
(a) adding said ASA sizing emulsion to said papermaking furnish, pulp, or fiber stock; or
(b) adding said ASA sizing emulsion to said high ash furnish comprising ash selected from the group consisting of calcium carbonate, TiO2, kaolin clay, silicates, carbonate based pigments, kaolin based pigments, or any combination of the foregoing, wherein said high ash furnish comprises a percent ash content of 1-35%, 2-30%, 5-25%, or 10-20% by mass, preferably 5%-25% ash by mass.

In some exemplary embodiments said ASA sizing agent comprises:
(a) an ASA solid, an ASA waxy solid, an ASA waxy liquid, an ASA liquid, or a mixture thereof; and
(b) a single ASA sizing agent or a mixture of ASA sizing agent molecules and/or isomers.

In some exemplary embodiments of the method (i) said primary emulsifying agent comprises an aqueous polymer solution comprising one or more cationic polymers and water; and (ii) said secondary emulsifying agent comprises one or more cationic starches.

In some exemplary embodiments said aqueous polymer solution comprises a percent solids by weight of said one or more cationic polymers ranging from 1-70%, 2-50%, or 5-30%.

In some exemplary embodiments said one or more cationic polymers comprise:
(a) one or more synthetic copolymers, terpolymers, or tetrapolymers comprising acrylamide and one or more cationic monomers selected from the group consisting of
   (i) diallyldialkylammonium halides, including but not limited to, diallyldimethylammonium chloride (“DADMAC”) and diallyldiethylammonium chloride;
   (ii) N,N-dialkylaminoalkyl acrylates, N,N-dialkylaminoalkyl (meth)acrylates, and acid addition salts and/or quaternary ammonium salts thereof, including but not limited to, acryloyloxyethyltrimethyl ammonium chloride (“AETAC”), methacryloyloxyethyltrimethylammonium chloride (“MAETAC”), dimethylaminoethyl acrylate (“DMAEA”) and acid addition salts thereof, dimethylaminoethyl methacrylate (“DMAEMA”) and acid addition salts thereof, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate, methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt;
   (iii) N,N-dialkylaminoalkylacrylamides and N,N-dialkylaminoalkyl (meth)acrylamides and acid addition salts or quaternary ammonium salts thereof, including but not limited to, acrylamidopropyltrimethylammonium chloride (“APTAC”), methacrylamidopropyltrimethylammonium chloride (“MAPTAC”), dimethylaminopropyl acrylamide methyl sulfate quaternary salt, dimethylaminopropyl acrylamide sulfuric acid salt, dimethylaminopropyl acrylamide hydrochloric acid salt, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; or
   (iv) any combination of (i)-(iii);
(b) said one or more synthetic copolymers, terpolymers, or tetrapolymers of (a), optionally containing:
   (i) one or more additional non-ionic monomers selected from the group consisting of methacrylamide; N-alkylacrylamides, including but not limited to, N-methylacrylamide, N-ethylacrylamide, N-propylacrylamide, and N-butylacrylamide; N,N-dialkylacrylamides, including, but not limited to, N,N-dimethylacrylamide and N,N-diethylacrylamide; N-alkyl methacrylamides; alkyl acrylates; hydroxyalkyl acrylates and methacrylates, including but not limited to, hydroxymethyl acrylate, 2-hydroxyethyl acrylate, 3-hydroxypropyl acrylate, 4-hydroxybutyl acrylate, hydroxymethyl methacrylate, 2-hydroxyethyl methacrylate, 3-hydroxypropyl methacrylate, and 4-hydroxybutyl methacrylate; dihydroxyalkyl acrylates and methacrylates, including but not limited to, 2,3-dihydroxypropyl acrylate, 3,4-dihydroxybutyl acrylate, 2,3-dihydroxypropyl methacrylate (DHPMA), and 3,4-dihydroxybutyl methacrylate; alkyl acrylates, including but not limited to, methyl methacrylate; acrylonitrile; N-vinylmethylacetamide, N-vinylmethylformamide; N-vinyl acetate, glyoxalated acrylamides, and vinyl pyrrolidone;
   (ii) one or more additional anionic monomers selected from the group consisting of acrylic acid, methacrylic acid, sulfonic acids, phosphonic acids, and alkali metal salts, alkaline earth metal salts, and ammonium salts thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid; or
   (iii) any combination of (i)-(ii):
(c) one or more cationic glyoxalated polyacrylamide (GPAM) polymers obtainable by reaction of glyoxal with said one or more synthetic copolymers, terpolymers, or tetrapolymers of (a), said one or more synthetic copolymers, terpolymers, or tetrapolymers of (b), or a combination thereof.
(d) one or more semisynthetic polymers comprising said one or more synthetic copolymers, terpolymers, or tetrapolymers of (a) or (b) optionally grafted onto one or more natural polymers, including but not limited to, starch, chitin, chitosan, and natural polysaccharides; or
(e) any combination of (a)-(d), and wherein said one or more cationic polymers has a weight average molecular weight ranging from 10,000-3,000,000 Da, 10,000-2,000,000 Da, 10,000-1,000,000 Da, 10,000-500,000 Da, 10,000-200,000 Da, 10,000-100,000 Da, or 10,000-50,000 Da.

In some exemplary embodiments said one or more cationic starches;
(a) comprise one or more cationic modified or unmodified starches selected from the group of starches consisting of corn starch, waxy maize starch, potato starch, tapioca starch, wheat starch, rice starch, barley starch, pea starch, sweet potato starch, and any combination thereof; and
(b) have a percent nitrogen (% N) content ranging from 0.2-2%, 0.2-1.75%, 0.2-1.5%, 0.2-1.25%, 0.2-1%, or 0.25-0.45% by mass, preferably 0.35-1.45% by mass.

In some exemplary embodiments said one or more cationic starches is formulated prior to addition to said ASA sizing agent by a method comprising:
(a) dissolving a dry cationic starch in water; cooking by a method, including but not limited to, jet cooking, steam cooking, or pot cooking; and cooling to a temperature ranging from 20-80° C., 20-60° C., 20-40° C., or 20-25° C., preferably 20-40° C. to obtain a cooked starch solution having percent solids ranging from 1-10%, 2-8%, or 3-6% by mass; or
(b) obtaining a pre-gelatinized cationic starch having percent solids ranging from 20% to 40% by mass and diluting with water to obtain a pre-gelatinized starch solution having a percent solids ranging from 1-10%, 2-8%, or 3-6% by mass.

In some exemplary embodiments of the method, (i) said one or more cationic polymers are selected from the group consisting of acrylamide/[2-(methyl-acryloyloxy)ethyl]trimethylammonium chloride copolymer (AMD/MAETAC), acrylamide/[2-(methylacryloyloxy)ethyl]trimethylammonium chloride/2-hydroxyethy methacrylate (AMD/MAETAC/HEMA) terpolymers, acrylamide/[2-(methylacryloyloxy)ethyl]trimethylammonium chloride/2-hydroxyethy methacrylate/acrylic acid (AMD/MAETAC/HEMA/AA) tetrapolymers, and acrylamide/[2-(methylacryloyloxy)ethyl]trimethylammonium chloride/2,3-dihydroxypropyl methacrylate (AMD/MAETAC/DHPMA) terpolymer and (ii) said one or more cationic starches comprises corn starch, waxy maize starch, potato starch, tapioca starch, wheat starch, or pea starch.

In some exemplary embodiments the method comprises one or more of the following:
(a) adding said primary emulsifying agent to said alkenyl succinic anhydride (ASA) sizing agent to a obtain a ratio of grams of active cationic polymer to grams of ASA of 0.05:1 to 0.6:1, 0.1:1 to 0.5:1, 0.15:1 to 0.4:1, or 0.2:1 to 0.25:1; and
(b) adding said secondary emulsifying agent to said primary emulsion to obtain a ratio by mass of dry starch to ASA of 0.25:1 to 2:1, 0.3:1 to 1.6:1, 0.4:1 to 1.2:1, or 0.5:1 to 1:1.

In some exemplary embodiments the method comprises:
(a) adding said primary emulsifying agent to said ASA sizing agent at ambient temperature and emulsifying by agitating with sufficient energy to achieve a median ASA particle size ranging from 0.5-3 μm, 0.5-2 μm, or 0.5-1 μm in diameter;
(b) adding said secondary emulsifying agent to said primary emulsion at a temperature ranging from 20-80° C., 20-60° C., 20-40° C., or 20-25° C., preferably 20-40° C. and emulsifying by agitating with sufficient energy to achieve a median ASA particle size ranging from 0.5-3 μm, 0.5-2 μm, or 0.5-1 μm in diameter.

In some exemplary embodiments said ASA sizing emulsion, in final form:
(a) comprises a median particle size ranging from 0.5-1 μm, 0.6-0.9 μm, or 0.7-0.8 μm in diameter;
(b) comprises a viscosity ranging from 10-100 cP, 20-90 cP, 30-80 cP, 40-70 cP, or 50-60 cP, when measured by a Brookfield viscometer with spindle 62 at 60 rpm and 20° C.;
(c) has a stability of 1-4 min, 1-10 min, 1 min-1 h, 1-6 h, 1-12 h, 1-24 h, or 1-48 h, wherein said stability is determined by said ASA sizing emulsion retaining
   (1) a median particle size of 0.5-3 μm, 0.5-2 μm, 0.5-1 μm, 0.6-0.9 μm, or 0.7-0.8 μm in diameter, preferably less than 1 μm in diameter; and/or
   (2) a viscosity ranging from 10-100 cP, 20-90 cP, 30-80 cP, 40-70 cP, or 50-60 cP, preferably less than 100 cP, when measured by a Brookfield viscometer with spindle 62 at 60 rpm and 20° C.;
(d) is immediately added to a papermaking furnish, pulp, or fiber stock, optionally a high ash furnish or is stored in a storage tank or holding facility for a storage time of 1-4 min, 1-10 min, 1 min-1 h, 1-6 h, 1-12 h, 1-24 h, or 1-48 h prior to addition of said ASA sizing emulsion to a papermaking furnish, pulp, or fiber stock, optionally a high ash furnish;
(e) comprises a decreased final ratio by mass of dry starch to ASA compared to an ASA sizing emulsion prepared by a single or dual emulsification method using one or more emulsifying agents comprising one or more cationic starches; or
(f) any combination of (a)-(e).

In some exemplary embodiments the method, when said stable alkenyl succinic anhydride (ASA) sizing emulsion is used as a sizing agent during the manufacture of paper or board it results in a sheet-like product selected from the group consisting of a high ash paper or board, a printing or writing grade paper or board, an alkaline printing or writing grade paper or board, a bleached paper or board, a packaging grade paper or board, and a partially recycled or 100% recycled paper or board, wherein said sheet like product comprises optimal sizing performance as measured by industry standardized testing, including, but not limited to, HST, Cobb, water drop testing, contact angle, edge-wick or water penetration, wherein said optimal sizing performance is determined in relation to an equivalent sheet-like product comprising an ASA sizing emulsion prepared by a single or dual emulsification method using one or more emulsifying agents comprising one or more cationic starches.

In another aspect, the present invention provides a dual emulsification method for preparation of an alkenyl succinic anhydride (ASA) sizing emulsion for use in manufacturing of paper and board, the method comprising:
(a) obtaining or producing an alkenyl succinic anhydride (ASA) sizing agent;
(b) combining said ASA sizing agent with a primary emulsifying agent and emulsifying at ambient temperature and agitating with sufficient energy to achieve a median ASA particle size ranging from 0.5-3 μm, 0.5-2 μm, or 0.5-1 μm in diameter thereby forming a primary emulsion; and
(c) after step (b), adding a secondary emulsifying agent and emulsifying at a temperature ranging from 20-80° C., 20-60° C., 20-40° C., or 20-25° C., preferably 20-40° C. and agitating with sufficient energy to achieve a median ASA particle size ranging from 0.5-3 μm, 0.5-2 μm, or 0.5-1 μm in diameter thereby forming said ASA sizing emulsion, and
(d) optionally, after step (c), adding said ASA sizing emulsion to a high ash papermaking furnish, wherein
   (i) said primary emulsifying agent comprises an aqueous polymer solution comprising cationic copolymers of acrylamide selected from the group consisting of acrylamide/[2-(methyl-acryloyloxy)ethyl]trimethylammonium chloride copolymer (AMD/MAETAC), acrylamide/[2-(methylacryloyloxy)ethyl]trimethylammonium chloride/2-hydroxyethy methacrylate (AMD/MAETAC/HEMA) terpolymers, acrylamide/[2-(methylacryloyloxy)ethyl]trimethylammonium chloride/2-hydroxyethy methacrylate/acrylic acid (AMD/MAETAC/HEMA/AA) tetrapolymers, and acrylamide/[2-(methylacryloyloxy)ethyl]trimethylammonium chloride/2,3-dihydroxypropyl methacrylate (AMD/MAETAC/DHPMA) terpolymer;
   (ii) said secondary emulsifying agent comprises one or more cationic modified or unmodified starches; selected from the group of starches consisting of corn starch, waxy maize starch, potato starch, tapioca starch, wheat starch, pea starch, and a mixture thereof;
   (iii) said high ash papermaking furnish comprises ash selected from the group consisting of calcium carbonate, TiO2, kaolin clay, silicates, carbonate-based pigments, kaolin based pigments, or any combination of the foregoing;
   (iv) said high ash papermaking furnish comprises a percent ash content of 1-35%, 2-30%, 5-25%, or 10-20% by mass, preferably 5-25% ash by mass;
   (v) said primary emulsifying agent is added to said alkenyl succinic anhydride (ASA) sizing agent to a obtain a ratio of grams of active cationic polymer to grams of ASA of 0.05:1 to 0.6:1, 0.1:1 to 0.5:1, 0.15:1 to 0.4:1, or 0.2:1 to 0.25:1; and
   (vi) said secondary emulsifying agent is added to said primary emulsion to obtain a ratio by mass of dry starch to ASA of 0.25:1 to 2:1, 0.3:1 to 1.6:1, 0.4:1 to 1.2:1, or 0.5:1 to 1:1.

In another aspect, the present invention provides an ASA sizing emulsion composition or a papermaking furnish, pulp, or fiber stock, optionally a high ash furnish, comprising said ASA sizing emulsion composition, obtainable by a method according to any of the foregoing.

In another aspect, the present invention provides a process for the production of paper or board, the process comprising obtaining a high ash furnish, comprising wood pulp, optionally fiber stock comprising a high content of recycled fibers and/or mill broke fibers, optionally a thick fiber stock, optionally a bleached fiber stock, optionally containing process water from pulp, paper, or board production and treating said fiber stock at the wet end of a paper machine with an ASA sizing emulsion according to any of the foregoing claims, wherein:
(a) said high ash furnish comprises ash selected from the group consisting of calcium carbonate, TiO2, kaolin clay, silicates, carbonate-based pigments, kaolin based pigments, or any combination of the foregoing; and
(b) said high ash furnish comprises a percent ash content of 1-35%, 2-30%, 5-25%, or 10-20% by mass, preferably 5%-25% by mass.

### BRIEF DESCRIPTION OF THE DRAWINGS

The invention will be described in more detail with reference to appended drawings, described in detail below.

FIG. 1 provides an exemplary flow chart for conventional emulsification of ASA (Conventional) and the inventive dual emulsification method (New Two-Step Approach) according to Example 1.

FIG. 2 shows an exemplary table of primary, secondary, and control ASA emulsion compositions, particle sizes, and viscosity measurements according to Example 1.

FIG. 3 shows an exemplary variability chart of Cobb values indicating amount of water absorption into handsheets prepared with inventive dual emulsified ASA sizing emulsions and control ASA sizing emulsions according to Example 2.

FIG. 4 shows an exemplary variability chart of Hercules size test (HST) indicating amount of ink penetration into handsheets prepared with inventive dual emulsified ASA sizing emulsions and control ASA sizing emulsions according to Example 2.

FIG. 5 shows an exemplary bar graph of HST values indicating the deficiency of starch only or synthetic polymer only, when used as emulsifying agents for ASA sizing emulsions for sizing of high ash paper furnish according to Example 3.

FIG. 6 shows an exemplary bar graph of Cobb values indicating similar sizing performance for ASA emulsions prepared using the inventive dual emulsification method (red bars) compared to starch only (blue bars) according to Example 3.

### DETAILED DESCRIPTION OF THE INVENTION

Before describing the invention, the following definitions are provided. Unless stated otherwise all terms are to be construed as they would be by a person skilled in the art.

### Definitions

As used herein the singular forms “a”, “and”, and “the” include plural referents unless the context clearly dictates otherwise.

As used herein, the terms “percent N content” and “% N content” refers to the molar percent of nitrogen substitution of cationic starch.

As used herein, the term “retention” refers to the efficiency with which small particles or chemical additives remain in the paper during its formation rather than staying with the white water.

As used herein, the terms “papermaking process” and “papermaking application” generally refers to any process in which any form of paper and/or paperboard product may be produced. For example, such processes include making paper products from pulp, such as methods comprising forming an aqueous cellulosic papermaking furnish, draining the furnish to form a sheet, and drying the sheet. The steps of forming the papermaking furnish, draining and drying may be carried out in any conventional manner generally known in the art. In some instances, papermaking processes and applications may comprise the use of one or more sizing agents, which are added to papermaking furnish.

As used herein, the term “fiber” refers to the basic structural unit of paper or board.

As used herein, the terms “recycled fiber” and “recovered fiber”, refer to paper, paperboard, and fibrous wastes from retail stores, office buildings, homes, manufacturing plants, and so forth, after they have passed through their end-usage as a consumer item. Manufacturing wastes include: dry paper and paperboard waste generated after completion of the papermaking process including by way of example: envelope cuttings, bindery trimmings, and other paper and paperboard waste resulting from printing, cutting, forming, and other converting operations; bag, box, and carton manufacturing wastes; mill wrappers, and rejected unused stock; and repulped finished paper and paperboard from obsolete inventories of paper and paperboard manufacturers, merchants, wholesalers, dealers, printers, converters, or others. In particular the term “recycled fibers” includes recycled fibers derived by processing of paper and other consumer cellulosic materials, e.g., paper, old corrugated containerboard (OCC), mixed office waste (MOW), old magazine (OMG), unbleached kraft pulp, neutral sulphite semi chemical (NCCS) pulp and/or mechanical pulp. Source materials for recycled fibers may be selected from old corrugated containerboard, mixed office waste, old newsprint, old magazines, double liner kraft, and any mixtures thereof. Mixed waste (MXW) denotes recycled mixture of recycled board, such as OCC, white lined chipboard and/or folding boxboard, and recycled paper, such as old newsprint, old magazines and/or office waste papers. Mixed office waste denotes recycled fiber material mainly containing copying papers, printer papers and offset papers. Double lined kraft denotes recycled fiber material comprising clean sorted unprinted corrugated cardboard cartons, boxes, sheet or trimmings, e.g. of kraft or jute liner. White lined chipboard (WLC) denotes multiply board comprising deinked fiber material and/or un-deinked recycled fiber material originating e.g., from OCC, mixed office waste or old newspapers (ONP) in or more of the layers. Presence of any of these recycled fiber materials in the fiber suspension usually decreases drainage and paper strength and provides a substantial load of starch, hydrophobic, and colloidal substances to the process.

As used herein, the term “OCC” refers to old corrugated cardboard and/or containerboard. Corrugated refers to those boxes where the materials are made from three separate layers of paper, two liners and a corrugated, or wavy, layer sandwiched between them. Brown paper bags are commonly accepted with OCC for recycling. The term OCC denotes recycled fiber material which have liners of test liner, jute or kraft, and may cover also double sorted corrugated containerboard (DS OCC).

As used herein, the terms “broke” or “mill broke” refer to paper, which during the paper making process becomes suitable only for repulping e.g., trimmings or paper that is out of specification. Broke is re-used material which never left the mill is not regarded as recycled or recovered. Broke is a valuable source of fiber and is recycled internally at the mill.

As used herein, the term “fiber suspension” is understood as an aqueous suspension, which comprises fibers, preferably recycled fibers, and optionally fillers. For example, the fiber suspension may comprise at least 5%, 10-30%, 11-19% of mineral filler, preferably 5%-25% by mass for wood free communication and specialty papers. Mineral filler may be any filler conventionally used in paper and board manufacturing, such as ground calcium carbonate, precipitated calcium carbonate, clay, talc, gypsum, titanium dioxide, synthetic silicate, aluminum trihydrate, barium sulphate, magnesium oxide or their any of mixtures.

As used herein, the terms “furnish” or “papermaking furnish” generally refers to a mixture of cellulosic fibers, pulp, optional fillers, dyes, and water from which paper or board is made.

As used herein, the term “thick stock” generally refers to mixture of papermaking pulp and other materials with a consistency of about 1 to 5%.

As used herein, the term “thin stock” generally refers to a mixture of papermaking pulp and other materials, after having been diluted to a consistency below 1% with whitewater or other process water at a fan pump.

As used herein, the term “high ash furnish” refers to furnishes comprises ash components, including but not limited to, calcium carbonate, TiO2, kaolin clay, silicates, carbonate based pigments, kaolin based pigments, or any combination of the foregoing. High ash papermaking furnishes are considered to comprise a percent ash content of 1-35%, 2-30%, 5-25%, or 10-20% by mass, preferably 5%-25% by mass for wood free communication and specialty papers. Such furnishes are typically used in papermaking applications for the production of alkaline writing grade or printing grade paper and packaging materials.

As used herein, the term “sizing agent” generally refers to various substances, typically hydrophobic, that are used to facilitate the water-resistant protection of a material surface (e.g., paper, board, textile, or composite material). These substances are typically used to prevent liquid absorption into the paper.

As used herein, the term “sizing performance” or “optimal sizing performance” may be determined by industry standardized testing, including, but not limited to: HST, Cobb, water drop testing, contact angle, edge-wick or water penetration. Neither HST nor Cobb are exclusive to ink and water resistance, respectively. Both tests are used depending on the level of size necessary based on the end use. The sizing requirement for (office) printing paper is not demanding so the HST test is often a good fit and more automated. For higher sizing demand, Cobb is often used and can be run for 1 or 2 minutes but up to 30 minutes for some packaging grades. Other sizing tests, such as water drop, edge wick, ink float and contact angle, may also be utilized. The media for HST and ink float is typically a green dyed 1% formic acid solution, while the other tests typically use water except edge wick which can use different media than those noted here.

As used herein, the terms “fixation”, “fixing” and “fix” means that a substance is associated or attached onto the fibers at least temporarily or permanently.

As used herein, the terms “polymer” or “polymeric additives” and similar terms are used in their ordinary sense as understood by one skilled in the art, and thus may be used herein to refer to or describe a large molecule (or group of such molecules) that may comprise recurring units. Polymers may be formed in various ways, including by polymerizing monomers and/or by chemically modifying one or more recurring units of a precursor polymer. Unless otherwise specified, a polymer may comprise a “homopolymer” that may comprise substantially identical recurring units that may be formed by, for example, polymerizing, a particular monomer. Unless otherwise specified, a polymer may also comprise a “copolymer” that may comprise two or more different recurring units that may be formed by, for example, copolymerizing, two or more different monomers, and/or by chemically modifying one or more recurring units of a precursor polymer. Unless otherwise specified, a polymer or copolymer may also comprise a “terpolymer” or a “tetrapolymer” which generally refer to polymers that comprise three, four, or more different recurring monomer units. Any one of the one or more polymers discussed herein may be used in any applicable process, for example, as a primary emulsifying agent for forming ASA sizing emulsions.

As used herein, the term “monomer” generally refers to nonionic monomers, anionic monomers, cationic monomers, zwitterionic monomers, betaine monomers, and amphoteric ion pair monomers.

As used herein, the term “anionic monomers” may refer to either anionic monomers that are substantially anionic in whole or (in equilibrium) in part, at a pH in the range of about 4.0 to about 9.0. The “anionic monomers” may be neutral at low pH (from a pH of about 2 to about 6), or to anionic monomers that are anionic at low pH.

As used herein, the term “cationic monomer” generally refers to a monomer that possesses a positive charge or a monomer that is positively charged at a pH within the normal operating range of paper machine processes.

As used herein, the term “water-soluble” generally refers to polymer products that are fully miscible with water. When mixed with excess of water, the cationic emulsion polymer in the polymer product is preferably fully dissolved and the obtained polymer solution is preferably free from discrete polymer particles or granules.

As used herein, the term “aqueous solution” or “solution” generally refers to a mixture of water and a water-soluble solute or solutes which are completely dissolved. The solution may be homogenous. When mixed with excess of water, the cationic emulsion polymer in the polymer product is preferably fully dissolved and the obtained polymer solution is preferably free from discrete polymer particles or granules.

As used herein, the terms “wet end of a paper machine” or “wet end” generally refer to the parts of a papermaking process between pulping (or bleaching) and wet-pressing of the paper.

The terms, “total solids” or “total suspended solids” are used interchangeably herein and generally refer the total amount or weight of suspended solids such as cellulosic fiber, cellulosic fibers and mineral pigments contained in aqueous media. “Total solids” or “total suspended solids” generally does not include dissolved solids.

As used herein, the terms “lbs/ton” or “#/T” denote pounds of dry mass of added material (e.g., additive, solute, and/or particle) per ton of suspended solids (e.g., weight of ASA per total dry ton of suspended solids).

As used herein, the phrases “% by wt.” denotes pounds of dry mass of additive per dry mass of solids in the formulation, solution, or slurry, multiplied by 100%.

The term “alkenyl succinic anhydride” or “ASA” generally refers to alkenyl succinic anhydride compounds composed of monounsaturated hydrocarbon chains containing pendant succinic anhydride groups. The alkenyl succinic anhydride compounds are generally liquid and may be derived from maleic anhydride and suitable olefins. The alkenyl succinic anhydride compounds may be solid.

The ASA sizes useful in the subject of this invention are generally described by the following structural formula:

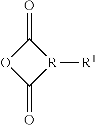

wherein R represents a dimethylene or trimethylene radical, and wherein R is a hydrophobic group containing more than 5 carbon atoms which may be selected from the group consisting of alkyl, alkenyl, aralkyl or aralkenyl groups.

Generally speaking, the alkenyl succinic anhydride compounds may be made by reacting an isomerized C14-C20 mono olefin, preferably an excess of an internal olefin, with maleic anhydride, at a temperature and for a time sufficient to form the alkenyl succinic anhydride compound.

If the olefin to be employed in the preparation of the alkenyl succinic anhydride compounds is not an internal olefin as is the case for example, with α-olefins, it may be preferable to first isomerize the olefins to provide internal olefins. The olefins that may be used in the preparation of the alkenyl succinic anhydride compounds may be linear or branched. Preferably, the olefins may contain at least about 14 carbon atoms. Typical structures of alkenyl succinic anhydride compounds are disclosed, for example, in U.S. Pat. No. 4,040,900, incorporated herein by reference in its entirety. Alkenyl succinic anhydride compounds and methods for their preparation are described, for example, in C. E. Farley and R. B. Wasser, “The Sizing of Paper, Second Edition,” edited by W. F. Reynolds, TAPPI Press, 1989, pages 51-62, the disclosures of which are hereby incorporated herein by reference in its entirety.

The alkenyl succinic anhydride component may contain some hydrolyzed alkenyl succinic anhydride. The amount of hydrolyzed alkenyl succinic anhydride may range from about 1 to about 99 wt. %, based on the total weight of the alkenyl succinic anhydride component. The alkenyl succinic anhydride component is generally present in the emulsion in an amount that is at least about 0.01 wt. %, or from about 0.1 to about 20 wt. %, or from about 0.3 wt. % to about 15 wt. %, based on the total weight of the emulsion. In another embodiment, the alkenyl succinic anhydride component is present in the emulsion in an amount that is from about 20 to about 40 wt. %.

As used herein, the terms “starch” and “cationic starch” generally refer to cationic agents various cationic starch derivatives including primary, secondary, tertiary, or quaternary amine starch derivatives and other cationic nitrogen substituted starch derivatives, as well as cationic sulfonium and phosphonium starch derivatives. Such derivatives, as stated by the patentee, may be prepared from all types of starches including corn starch, waxy maize starch, potato starch, tapioca starch, wheat starch, rice starch, barley starch, pea starch, sweet potato starch, and any combination thereof.

Cationic starches may formulated prior to use in a papermaking process by a method such as dissolving a dry cationic starch in water; cooking by a method, including but not limited to, jet cooking, steam cooking, or pot cooking; and cooling to a temperature ranging from 20-80° C., 20-60° C., 20-40° C., or 20-25° C., preferably 20-40° C. to obtain a cooked starch solution having percent solids ranging from 1-10%, 2-8%, or 3-6% by mass; or obtaining a pre-gelatinized cationic starch having percent solids ranging from 20% to 40% by mass and diluting with water to obtain a pre-gelatinized starch solution having a percent solids ranging from 1-10%, 2-8%, or 3-6% by mass. Any one of the one or more starches discussed herein may be used in any applicable process, for example, as a secondary emulsifying agent for forming ASA sizing emulsions.

Methods used to measure the molecular weight of polymers include the light scattering method, osmotic pressure method, and viscosity method. These allow obtaining the average molecular weight values. However, many polymers consist of molecules with not just one molecular weight, but rather a collection of molecules with many different molecular weights.

As used herein, the terms “molecular weight” or “weight average molecular weight” or “MW” refer to the weight fraction of molecules in a polymer sample. MW of a polymer may be determined by gel permeation chromatography (GPC), which is a type of size exclusion chromatography (SEC). It is mainly used to measure the molecular weight of polymer compounds based on retention time on a size exclusion column under standardized conditions. Other methods used to determine the weight average molecular weight of polymers include light scattering and ultracentrifuge methods.

As used herein, the phrase “agitating with sufficient energy” or “emulsifying by agitating with sufficient energy” generally refers to high shear agitation of ASA to provide an emulsion and achieve adequate results of mixing. The mixing agitation devices that are used to mix the ingredients of the ASA emulsion must accomplish the formation of emulsion having sufficient stability (e.g., 1-2 hours, 1-20 hours, 1-24 hours, or 1-48 hours), sufficient average particle size (e.g., not more than 3, 2, or 1 μm in diameter), sufficient particle size distribution (e.g., 95% of particles having a diameter of not more than 3 μm), and sufficient intrinsic viscosity (e.g., not more than 100 cP, when measured by a Brookfield viscometer with spindle 62 at 60 rpm and 20° C.) for use as a sizing emulsion at the wet end of a paper machine. Prior to adding the inventive ASA emulsions to a paper machine, it is common to expose the ingredients of the emulsions to a mixing pump which accomplishes a mixing of the pertinent ingredients of these emulsions. The mixing can be accomplished in several ways (e.g., static mixing, pump mixing, in-line mixing, or any means of mixing known in the art). The ingredients of the inventive ASA sizing emulsions may be added into the feed side of a pump capable of emulsion formations. The discharge of this pump may be split so that a portion of the discharge goes to the paper machine while another portion of the discharge is fed back to the feed point of the pump. By controlling the percentage of output of this type of pump which is recirculated back to the feed point of the pump, one may control the amount of energy that the components of the emulsion are exposed to and thereby control the quality of the emulsion formed by the ASA sized emulsion ingredients. The use of sufficient energy, as controlled by output recycle ratios, can control ASA size emulsion particle size within the ranges taught above. By controlling the ratio of output to feedback from the emulsifying pump one can control the particle size of the emulsion to achieve the desired physical characteristics of these ASA emulsion sizes. Alternatively, the emulsion-forming pump may be operated such that no discharge is recycled to the feed point. To obtain adequate emulsion quality, it is then preferred that the pump be operated at pressures exceeding atmospheric pressures.

### DESCRIPTION OF THE INVENTION

The present invention generally relates to compositions and methods for preparation of an alkenyl succinic anhydride (ASA) sizing emulsion for use in manufacturing of paper and board. In particular, the disclosure provides methods for dual emulsification of ASA using a cationic polymer as the primary emulsification agent and cationic starch as the secondary emulsification agent to impart superior stability to the emulsion and enhance sizing performance in high ash papermaking, at considerable reduction in overall starch utilization compared to conventional natural polymer ASA emulsification applications.

Sizing is a process that reduces the extent to which dry paper or dry board absorbs fluids. Sizing of paper or board improves water resistance, reduces permeability to fluids, and prevents ink and print from blurring. Two commonly used methods are internal sizing and surface sizing. Internal sizing is widely used in a large variety of papers, while surface sizing is generally used for production of higher grade papers.

Internal sizing involves treatment of the fiber slurry with sizing agents so that the paper will resist the absorption of fluids. Internal sizing agents are added to fibers at the wet end of the papermaking process and generally form a strong bond to the fibers. Desirable characteristics of internal sizing agents include high hydrophobicity, high degree of retention on fibers, and uniform distribution throughout the fiber. Alkyl succinic anhydride (ASA) is a commonly used internal sizing agent, which reacts with hydroxyl groups on cellulose fibers via esterification reactions, thereby anchoring to the fibers. The alkyl or alkenyl side chains of ASA impart hydrophobicity to the cellulosic material. Highly effective internal sizing agents reduce the amount fluid absorbed by paper measured by, but not limited to, Cobb test, Hercules size test, edge-wick, water drop, ink float, or any combination thereof.

ASA sizing agents tend to be hydrophobic, and they generally must be used in aqueous paper manufacturing systems. Considerable effort is required to achieve a uniform, stable ASA emulsion suitable for paper manufacture. Formulation of ASA sizes of the type described above has presented serious problems for the application of the sizes to paper stock or pulp prior to its formation into sheet or other useful forms. Part of the problem has been that the ASA sizing materials are not water soluble, and must, accordingly, be uniformly suspended in the pulp so that the size can make adequate contact with the cellulosic fibers and thus create the desired effect on the final product.

Additives which will serve to emulsify or disperse the ASA size in the pulp and allow for retention of the size onto the fiber. Cationic agents (e.g., various starch derivatives), together with other emulsifiers have been successfully used as emulsification agent for forming ASA emulsions having stability, viscosity, and particle size characteristics that are suitable for use in papermaking.

Presently, the availability of starch for commercial applications is severely limited, due to supply chain shortages. The present invention utilizes a dual emulsification technique using a cationic solution polymer in the primary emulsification step, followed by secondary emulsification in starch at low dose under shear. The dual emulsification imparts superior stability to the emulsion and enhances sizing performance in high ash papermaking, at considerable reduction in overal starch utilization compared to conventional natural polymer ASA emulsification applications.

In one aspect, the present invention provides a method for preparation of a stable alkenyl succinic anhydride (ASA) sizing emulsion which is suitable for use in manufacturing of paper and board, the method comprising:
(a) obtaining or producing an alkenyl succinic anhydride (ASA) sizing agent;
(b) combining said ASA sizing agent with a primary emulsifying agent and emulsifying to form a primary emulsion; and
(c) after step (b), adding a secondary emulsifying agent and emulsifying to form said ASA sizing emulsion, and
(d) optionally, after steps (a) to (c) adding the resultant stable ASA sizing emulsion to a papermaking furnish, pulp, or fiber stock, optionally a high ash furnish.

In some exemplary embodiments the method further comprises, after step (c):
(a) adding said ASA sizing emulsion to said papermaking furnish, pulp, or fiber stock; or
(b) adding said ASA sizing emulsion to said high ash furnish comprising ash selected from the group consisting of calcium carbonate, TiO2, kaolin clay, silicates, carbonate based pigments, kaolin based pigments, or any combination of the foregoing, wherein said high ash furnish comprises a percent ash content of 1-35%, 2-30%, 5-25%, or 10-20% by mass, preferably 5-25% ash by mass. Generally, the ideal ash range is 5%-25% for wood free communication and specialty papers.

In some exemplary embodiments said ASA sizing agent comprises:
(a) an ASA solid, an ASA waxy solid, an ASA waxy liquid, an ASA liquid, or a mixture thereof; and
(b) a single ASA sizing agent or a mixture of ASA sizing agent molecules and/or isomers.

In some exemplary embodiments of the method (i) said primary emulsifying agent comprises an aqueous polymer solution comprising one or more cationic polymers and water; and (ii) said secondary emulsifying agent comprises one or more cationic starches.

In some exemplary embodiments said aqueous polymer solution comprises a percent solids by weight of said one or more cationic polymers ranging from 1-70%, 2-50%, or 5-30%.

In some exemplary embodiments said one or more cationic polymers comprise:
(a) one or more synthetic copolymers, terpolymers, or tetrapolymers comprising acrylamide and one or more cationic monomers selected from the group consisting of
   (i) diallyldialkylammonium halides, including but not limited to, diallyldimethylammonium chloride (“DADMAC”) and diallyldiethylammonium chloride;
   (ii) N,N-dialkylaminoalkyl acrylates, N,N-dialkylaminoalkyl (meth)acrylates, and acid addition salts and/or quaternary ammonium salts thereof, including but not limited to, acryloyloxyethyltrimethyl ammonium chloride (“AETAC”), methacryloyloxyethyltrimethylammonium chloride (“MAETAC”), dimethylaminoethyl acrylate (“DMAEA”) and acid addition salts thereof, dimethylaminoethyl methacrylate (“DMAEMA”) and acid addition salts thereof, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate, methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt;
   (iii) N,N-dialkylaminoalkylacrylamides and N,N-dialkylaminoalkyl (meth)acrylamides and acid addition salts or quaternary ammonium salts thereof, including but not limited to, acrylamidopropyltrimethylammonium chloride (“APTAC”), methacrylamidopropyltrimethylammonium chloride (“MAPTAC”), dimethylaminopropyl acrylamide methyl sulfate quaternary salt, dimethylaminopropyl acrylamide sulfuric acid salt, dimethylaminopropyl acrylamide hydrochloric acid salt, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; or
   (iv) any combination of (i)-(iii);
(b) said one or more synthetic copolymers, terpolymers, or tetrapolymers of (a), optionally containing
   (i) one or more additional non-ionic monomers selected from the group consisting of methacrylamide; N-alkylacrylamides, including but not limited to, N-methylacrylamide, N-ethylacrylamide, N-propylacrylamide, and N-butylacrylamide; N,N-dialkylacrylamides, including, but not limited to, N, N-dimethylacrylamide and N,N-diethylacrylamide; N-alkyl methacrylamides; alkyl acrylates; hydroxyalkyl acrylates and methacrylates, including but not limited to, hydroxymethyl acrylate, 2-hydroxyethyl acrylate, 3-hydroxypropyl acrylate, 4-hydroxybutyl acrylate, hydroxymethyl methacrylate, 2-hydroxyethyl methacrylate, 3-hydroxypropyl methacrylate, and 4-hydroxybutyl methacrylate; dihydroxyalkyl acrylates and methacrylates, including but not limited to, 2,3-dihydroxypropyl acrylate, 3,4-dihydroxybutyl acrylate, 2,3-dihydroxypropyl methacrylate (DHPMA), and 3,4-dihydroxybutyl methacrylate; alkyl acrylates, including but not limited to, methyl methacrylate; acrylonitrile; N-vinylmethylacetamide, N-vinylmethylformamide; N-vinyl acetate, glyoxalated acrylamides, and vinyl pyrrolidone;
   (ii) one or more additional anionic monomers selected from the group consisting of acrylic acid, methacrylic acid, sulfonic acids, phosphonic acids, and alkali metal salts, alkaline earth metal salts, and ammonium salts thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid; or
   (iii) any combination of (i)-(ii);
(c) one or more cationic glyoxalated polyacrylamide (GPAM) polymers obtainable by reaction of glyoxal with said one or more synthetic copolymers, terpolymers, or tetrapolymers of (a), said one or more synthetic copolymers, terpolymers, or tetrapolymers of (b), or a combination thereof;
(d) one or more semisynthetic polymers comprising said one or more synthetic copolymers, terpolymers, or tetrapolymers of (a) or (b) optionally grafted onto one or more natural polymers, including but not limited to, starch, chitin, chitosan, and natural polysaccharides; or
(e) any combination of (a)-(d),
and wherein said one or more cationic polymers has a weight average molecular weight ranging from 10,000-3,000,000 Da, 10,000-2,000,000 Da, 10,000-1,000,000 Da, 10,000-500,000 Da, 10,000-200,000 Da, 10,000-100,000 Da, or 10,000-50,000 Da.

In some exemplary embodiments said one or more cationic starches;
(a) comprise one or more cationic modified or unmodified starches selected from the group of starches consisting of corn starch, waxy maize starch, potato starch, tapioca starch, wheat starch, rice starch, barley starch, pea starch, sweet potato starch, and any combination thereof; and
(b) have a percent nitrogen (% N) content ranging from 0.2-2%, 0.2-1.75%, 0.2-1.5%, 0.2-1.25%, 0.2-1%, or 0.25-0.45% by mass, preferably 0.35-1.45% by mass.

In some exemplary embodiments said one or more cationic starches is formulated prior to addition to said ASA sizing agent by a method comprising:
(a) dissolving a dry cationic starch in water; cooking by a method, including but not limited to, jet cooking, steam cooking, or pot cooking; and cooling to a temperature ranging from 20-80° C., 20-60° C., 20-40° C., or 20-25° C., preferably 20-40° C. to obtain a cooked starch solution having percent solids ranging from 1-10%, 2-8%, or 3-6% by mass; or
(b) obtaining a pre-gelatinized cationic starch having percent solids ranging from 20% to 40% by mass and diluting with water to obtain a pre-gelatinized starch solution having a percent solids ranging from 1-10%, 2-8%, or 3-6% by mass.

In some exemplary embodiments of the method, (i) said one or more cationic polymers are selected from the group consisting of acrylamide/[2-(methyl-acryloyloxy)ethyl]trimethylammonium chloride copolymer (AMD/MAETAC), acrylamide/[2-(methylacryloyloxy)ethyl]trimethylammonium chloride/2-hydroxyethy methacrylate (AMD/MAETAC/HEMA) terpolymers, acrylamide/[2-(methylacryloyloxy)ethyl]trimethylammonium chloride/2-hydroxyethy methacrylate/acrylic acid (AMD/MAETAC/HEMA/AA) tetrapolymers, and acrylamide/[2-(methylacryloyloxy)ethyl]trimethylammonium chloride/2,3-dihydroxypropyl methacrylate (AMD/MAETAC/DHPMA) terpolymer and (ii) said one or more cationic starches comprises corn starch, waxy maize starch, potato starch, tapioca starch, wheat starch, or pea starch.

In some exemplary embodiments the method comprises one or more of the following:
(a) adding said primary emulsifying agent to said alkenyl succinic anhydride (ASA) sizing agent to a obtain a ratio of grams of active cationic polymer to grams of ASA of 0.05:1 to 0.6:1, 0.1:1 to 0.5:1, 0.15:1 to 0.4:1, or 0.2:1 to 0.25:1; and
(b) adding said secondary emulsifying agent to said primary emulsion to obtain a ratio by mass of dry starch to ASA of 0.25:1 to 2:1, 0.3:1 to 1.6:1, 0.4:1 to 1.2:1, or 0.5:1 to 1:1.

In some exemplary embodiments the method comprises:
(a) adding said primary emulsifying agent to said ASA sizing agent at ambient temperature and emulsifying by agitating with sufficient energy to achieve a median ASA particle size ranging from 0.5-3 μm, 0.5-2 μm, or 0.5-1 μm in diameter; and/or
(b) adding said secondary emulsifying agent to said primary emulsion at a temperature ranging from 20-80° C., 20-60° C., 20-40° C., or 20-25° C., preferably 20-40° C. and emulsifying by agitating with sufficient energy to achieve a median ASA particle size ranging from 0.5-3 μm, 0.5-2 μm, or 0.5-1 μm in diameter.

In some exemplary embodiments said ASA sizing emulsion, in final form:
(a) comprises a median particle size ranging from 0.5-1 μm, 0.6-0.9 μm, or 0.7-0.8 μm in diameter;
(b) comprises a viscosity ranging from 10-100 cP, 20-90 cP, 30-80 cP, 40-70 cP, or 50-60 cP, when measured by a Brookfield viscometer with spindle 62 at 60 rpm and 20° C.;
(c) has a stability of 1-4 min, 1-10 min, 1 min-1 h, 1-6 h, 1-12 h, 1-24 h, or 1-48 h, wherein said stability is determined by said ASA sizing emulsion retaining
   (i) a median particle size of 0.5-3 μm, 0.5-2 μm, 0.5-1 μm, 0.6-0.9 μm, or 0.7-0.8μ m in diameter, preferably less than 1 μm in diameter;
   (ii) a viscosity ranging from 10-100 cP, 20-90 cP, 30-80 cP, 40-70 cP, or 50-60 cP, preferably less than 100 cP, when measured by a Brookfield viscometer with spindle 62 at 60 rpm and 20° C.;
(d) is immediately added to a papermaking furnish, pulp, or fiber stock, optionally a high ash furnish or is stored in a storage tank or holding facility for a storage time of 1-4 min, 1-10 min, 1 min-1 h, 1-6 h, 1-12 h, 1-24 h, or 1-48 h prior to addition of said ASA sizing emulsion to a papermaking furnish, pulp, or fiber stock, optionally a high ash furnish;
(e) comprises a decreased final ratio by mass of dry starch to ASA compared to an ASA sizing emulsion prepared by a single or dual emulsification method using one or more emulsifying agents comprising one or more cationic starches; or
(f) any combination of (a)-(e).

In some exemplary embodiments the method, when said stable alkenyl succinic anhydride (ASA) sizing emulsion is used as a sizing agent during the manufacture of paper or board it results in a sheet-like product selected from the group consisting of a high ash paper or board, a printing or writing grade paper or board, an alkaline printing or writing grade paper or board, a bleached paper or board, a packaging grade paper or board, and a partially recycled or 100% recycled paper or board, wherein said sheet like product comprises optimal sizing performance as measured by industry standardized testing, including, but not limited to, HST, Cobb, water drop testing, contact angle, edge-wick or water penetration, wherein said optimal sizing performance is determined in relation to an equivalent sheet-like product comprising an ASA sizing emulsion prepared by a single or dual emulsification method using one or more emulsifying agents comprising one or more cationic starches.

In another aspect, the present invention provides a dual emulsification method for preparation of an alkenyl succinic anhydride (ASA) sizing emulsion for use in manufacturing of paper and board, the method comprising:
(a) obtaining or producing an alkenyl succinic anhydride (ASA) sizing agent;
(b) combining said ASA sizing agent with a primary emulsifying agent and emulsifying at ambient temperature and agitating with sufficient energy to achieve a median ASA particle size ranging from 0.5-3 μm, 0.5-2 μm, or 0.5-1 μm in diameter thereby forming a primary emulsion; and
(c) after step (b), adding a secondary emulsifying agent and emulsifying at a temperature ranging from 20-80° C., 20-60° C., 20-40° C., or 20-25° C., preferably 20-40° C. and agitating with sufficient energy to achieve a median ASA particle size ranging from 0.5-3 μm, 0.5-2 μm, or 0.5-1 μm in diameter thereby forming said ASA sizing emulsion, and
(d) optionally, after step (c), adding said ASA sizing emulsion to a high ash papermaking furnish,
   wherein
(i) said primary emulsifying agent comprises an aqueous polymer solution comprising cationic copolymers of acrylamide selected from the group consisting of acrylamide/[2-(methyl-acryloyloxy)ethyl]trimethylammonium chloride copolymer (AMD/MAETAC), acrylamide/[2-(methylacryloyloxy)ethyl]trimethylammonium chloride/2-hydroxyethy methacrylate (AMD/MAETAC/HEMA) terpolymers, acrylamide/[2-(methylacryloyloxy)ethyl]trimethylammonium chloride/2-hydroxyethy methacrylate/acrylic acid (AMD/MAETAC/HEMA/AA) tetrapolymers, and acrylamide/[2-(methylacryloyloxy)ethyl]trimethylammonium chloride/2,3-dihydroxypropyl methacrylate (AMD/MAETAC/DHPMA) terpolymer;
(ii) said secondary emulsifying agent comprises one or more cationic modified or unmodified starches; selected from the group of starches consisting of corn starch, waxy maize starch, potato starch, tapioca starch, wheat starch, pea starch, and a mixture thereof;
(iii) said high ash papermaking furnish comprises ash selected from the group consisting of calcium carbonate, TiO2, kaolin clay, silicates, carbonate-based pigments, kaolin based pigments, or any combination of the foregoing;
(iv) said high ash papermaking furnish comprises a percent ash content of 1-35%, 2-30%, 5-25%, or 10-20% by mass, preferably 5%-25% ash by mass;
(v) said primary emulsifying agent is added to said alkenyl succinic anhydride (ASA) sizing agent to a obtain a ratio of grams of active cationic polymer to grams of ASA of 0.05:1 to 0.6:1, 0.1:1 to 0.5:1, 0.15:1 to 0.4:1, or 0.2:1 to 0.25:1; and
(vi) said secondary emulsifying agent is added to said primary emulsion to obtain a ratio by mass of dry starch to ASA of 0.25:1 to 2:1, 0.3:1 to 1.6:1, 0.4:1 to 1.2:1, or 0.5:1 to 1:1.

In another aspect, the present invention provides an ASA sizing emulsion composition or a papermaking furnish, pulp, or fiber stock, optionally a high ash furnish, comprising said ASA sizing emulsion composition, obtainable by a method according to any of the foregoing.

In another aspect, the present invention provides a process for the production of paper or board, the process comprising obtaining a high ash furnish, comprising wood pulp, optionally fiber stock comprising a high content of recycled fibers and/or mill broke fibers, optionally a thick fiber stock, optionally a bleached fiber stock, optionally containing process water from pulp, paper, or board production and treating said fiber stock at the wet end of a paper machine with an ASA sizing emulsion according to any of the foregoing claims, wherein:
(a) said high ash furnish comprises ash selected from the group consisting of calcium carbonate, TiO2, kaolin clay, silicates, carbonate based pigments, kaolin based pigments, or any combination of the foregoing; and
(b) said high ash furnish comprises a percent ash content of 1-35%, 2-30%, 5-25%, or 10-20% by mass, preferably 5-25% ash by mass.

The methods and compositions illustratively disclosed herein suitably may be practiced in the absence of any element which is not specifically disclosed herein and/or any element specifically disclosed herein. Exemplary embodiments of the invention and its advantages are further disclosed in the following examples.

### EXAMPLES

The examples provided herein are for illustrative purposes so that the invention may be more fully understood. These examples should not be construed as limiting the invention in any way.

### Example 1: Dual Emulsification Method for Preparation of Alkenyl Succinic Anhydride (ASA) Sizing Emulsions

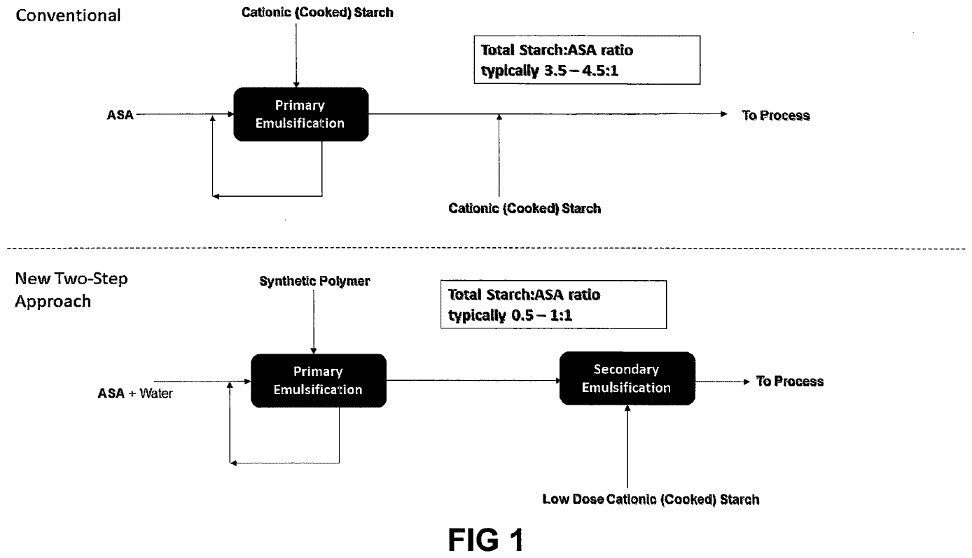

ASA sizing emulsions were prepared to be evaluated as sizing for paper or paperboard. The inventive dual emulsification methods, using a cationic solution polymer as a primary emulsifier in a primary emulsification step followed by a secondary emulsification using cationic starch as a secondary emulsifier at low dose under shear, was compared to conventional emulsification techniques using starch only as control. An exemplary flow chart for conventional emulsification of ASA and the inventive dual emulsification method (Novel Two-Step Approach) are shown in FIG. 1.

### Dual Emulsification Method

Alkenyl succinic anhydride (ASA) sizing emulsions were prepared in the lab by a dual emulsification procedure, while ensuring that shear speed and time were kept constant for all emulsions.

A primary emulsifying agent was prepared from a water based solution of a cationic polymer of acrylamide/[2-(methylacryloyloxy)ethyl]trimethylammonium chloride/2-hydroxyethy methacrylate (AMD/MAETAC/HEMA) terpolymer (Polymer 1).

A secondary emulsifying agent was prepared by cooking dry cationic modified corn starch in a jet cooker to obtain a liquid starch solution having a working solids content of 3-6% by mass (cooked starch, i.e., mill cooked wet end cationic starch). The starch had a % nitrogen content of 0.25-0.45% by mass. Alternatively, pre-gelatinized starch may be obtained with a typical solids content in the range of 20-40% by mass. This pre-gelatinized solution may be diluted with water on site to the desired working solids range of 3-6% by mass.

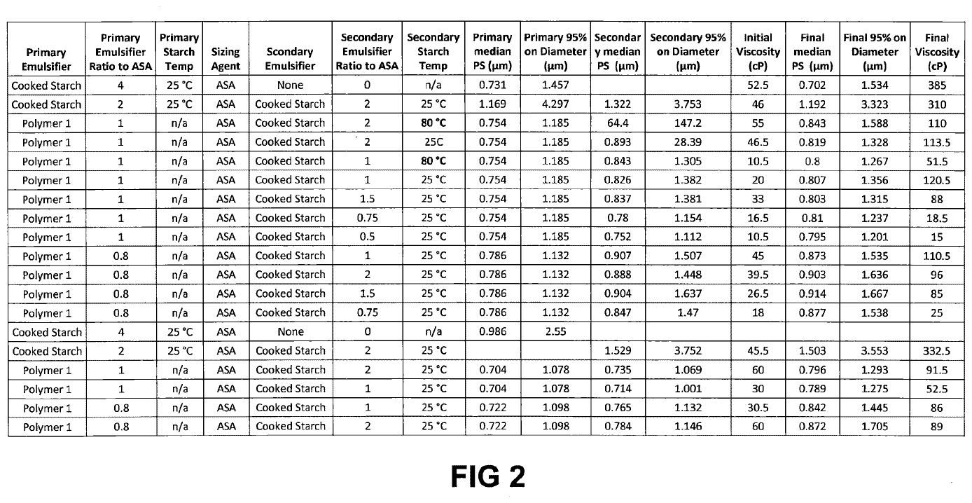

The primary emulsifying agent containing a solution of acrylamide-based polymer was added to alkenyl succinic anhydride (ASA) sizing agent in a ratio of primary emulsifier to ASA of 0.8:1 or 1:1 by mass, according to FIG. 2. Primary emulsification was performed at room temperature (20° C.) using a high shear pump until thoroughly emulsified to form a primary emulsion.

After a brief period of time (less than 10 minutes), the secondary emulsifying agent was added to the primary emulsion mixture in a ratio of secondary emulsifier (starch) to ASA of 0.5:1 to 2:1 by mass, and secondary emulsification was performed at room temperature (20° C.) or elevated temperature (80° C.), according to FIG. 2, using a high shear pump until thoroughly emulsified to form a dual emulsified (secondary) ASA sizing emulsion.

### Conventional (Control) Emulsification Methods

Singly emulsified and dual emulsified control emulsions were prepared according to standard techniques using the same cooked starch emulsifying agent described in the dual emulsification method.

For singly emulsified control samples, the cooked starch emulsifying agent was added at room temperature (20° C.) to alkenyl succinic anhydride (ASA) sizing agent in a primary emulsification step at a ratio of 4:1 by mass (starch to ASA), according to FIG. 2. Emulsification was performed using a high shear pump until thoroughly emulsified.

For singly emulsified control samples, the cooked starch emulsifying agent was added at room temperature (20° C.) to alkenyl succinic anhydride (ASA) sizing agent in a primary emulsification step at a ratio of 2:1 or 4:1 by mass (starch to ASA), according to FIG. 2. For dual emulsified control samples, a secondary emulsification was performed by adding the same cooked starch emulsifying agent at room temperature (20° C.) at a ratio of 2:1 by mass (starch to ASA), according to FIG. 2. Primary and secondary emulsifications were performed using a high shear pump until thoroughly emulsified.

Thorough emulsification was determined by the emulsion having a median ASA particle size ranging from 0.5-3 μm, 0.5-2 μm, or 0.5-1 μm in diameter and an ASA particle size distribution wherein 95% of ASA particles have a diameter of not more than 3 μm.

### Evaluation of ASA Emulsions

Primary, secondary, and control ASA emulsions, prepared according to the inventive dual emulsification methods and conventional (control) emulsification methods, were analyzed for particle size and viscosity.

Primary, secondary, and control ASA emulsions were analyzed for median particle size (median PS) and maximum particle diameter (95% on diameter) immediately after emulsification. Secondary and control ASA emulsions were also analyzed for initial viscosity immediately after emulsification. To determine relative stability of the emulsions, the secondary and control ASA emulsions were aged for 2 hours at room temperature (20° C.) and then analyzed for final particle size and final viscosity. Particle size and viscosity results are shown in FIG. 2.

For secondary emulsions before and after aging, a median particle size under 1 micron and 95% on diameter under 3 μm was deemed desirable for laboratory papermaking applications. Optimal particle size distribution is lower for field applications due to shear mechanics of the emulsification equipment achieving lower particle size emulsions.

Results indicate the inventive dual emulsification ASA samples made with cationic polymer as primary emulsifier (Polymer 1) and starch as the secondary starch emulsifier show good particle size. All dual emulsification ASA samples had a secondary median particle size under 1 μm before and after the 2 hour hold. Final 95% on diameter values were also well below 3 μm for all dual emulsification ASA samples. These particle size results indicate that the inventive dual emulsification method provides highly desirable particle size distributions that are stable for at least 2 hours.

The best final particle size results were achieved using a Polymer 1 to ASA ratio of 0.8:1 in the primary emulsifier and a starch to ASA ratio of 0.5:1 for the secondary emulsifier. Surprisingly, these particle size results were comparable to or better than control samples prepared using starch alone at a much higher starch to ASA ratio (e.g., 4:1 total).

Viscosity under 100 cP, when measured by a Brookfield viscometer with spindle 62 at 60 rpm and 20° C., after the 2-hour hold time was indicative of good emulsion stability and deemed desirable for papermaking applications.

Viscosity results for the inventive dual emulsification ASA samples were highly indicative of good ASA emulsion stability. All dual emulsification ASA samples displayed initial viscosity results under 100 cP and more than ⅔ of the samples maintained viscosity under 100 cP after the 2 hour hold, indicating good emulsion stability. Surprisingly, these results were comparable to or better than control samples prepared using starch alone at a much higher starch to ASA ratio (e.g., 4:1 total). By contrast, all control samples displayed extremely poor final viscosity results, indicating poor stability.

It was surprisingly observed that the inventive dual emulsification method was capable of reducing overall starch demand by 75-80%, while achieving equally desirable or enhanced particle sizes and stability based on viscosity.

Without being bound to theory, a mechanistic rationale for these surprising results is that the primary emulsification step with polymer as primary emulsifier results in particle sizes that are smaller and narrower compared to those formed with cooked starch as the primary emulsifier. The surface area is smaller, so less starch is needed in secondary step to achieve emulsions with comparable or superior stability. Additionally, using a shear pump during the secondary emulsion step facilitates starch incorporation onto the particles, further allowing for use of less starch. Typically, for conventional methods, shear pumping is only performed during the initial emulsification step.

Typically, during emulsification, ASA hydrolysis is an unwanted side reaction, which follows 1st order rate kinetics. Elevated temperature increases this the rate of hydrolysis. For this reason, starch is typically cooled to ambient temperature prior to addition to ASA to slow hydrolysis. It was surprising found that starch temperatures of 25° C. and 80° C. both provided enhancement in particle size and stability for the inventive dual emulsification technique.

These results provide proof of concept that the inventive dual emulsification method can be used to prepare dual emulsified ASA sizing emulsions with enhanced emulsion properties, while using less starch compared to conventional natural polymer ASA emulsification methods.

### Example 2: Evaluation of Dual Emulsified ASA Sizing Emulsions for Sizing of Handsheets

### Preparation of ASA Sized Handsheets

Dual emulsified ASA sizing emulsions and control emulsion (starch only) were prepared according to Example 1 with cationic polymer (Polymer 1) as the primary emulsifying agent and starch as the secondary emulsifying agent using emulsification conditions shown in Table 1. The resulting ASA emulsions were evaluated for emulsion quality based on particle size and viscosity, and then the emulsions were used as sizing for handsheets. Results for particle size and viscosity are shown in Table 1.

TABLE 1
ASA Emulsification conditions, particle sizes, and viscosity measurements for Handsheet studies.

| | Primary | | Secondary | Primary | Primary | Secondary | Secondary |
|---|---|---|---|---|---|---|---|
| | Polymer | | Starch | median | 95% on | median | 95% in |
| | Ratio | | Ratio | PS | diameter | PS | diameter |
| Primary Emulsifier | (to ASA) | Secondary Emulsifier | (to ASA) | (micron) | (micron) | (micron) | (micron) |
| Cationic Starch | 4 | none | 0 | 0.609 | 1.48 | | |
| Polymer 1 | 1 | Cationic Starch (25° C.) | 2 | 0.746 | 1.5 | 0.959 | 34.59 |
| Polymer 1 | 1 | Cationic Starch (80° C.) | 1 | 0.746 | 1.5 | 0.948 | 29.34 |
| Polymer 1 | 1 | Cationic Starch (25° C.) | 1 | 0.873 | 1.69 | 0.943 | 40.5 |
| Polymer 1 | 1 | Cationic Starch (25° C.) | 0.5 | 0.873 | 1.69 | 0.871 | 2.513 |
| Polymer 1 | 0.8 | Cationic Starch (25° C.) | 1 | 0.851 | 1.69 | 1.002 | 39.76 |
| Polymer 1 | 0.8 | Cationic Starch (25° C.) | 0.75 | 0.851 | 1.69 | 0.944 | 2.469 |

Handsheets were prepared on a Noble and Wood handsheet mold. The furnish was provided from a paper mill using a high filler (15%) HOPCC containing blend of hardwood and softwood. ASA sizing emulsions were incorporated into the furnish. Efforts were made to simulate the mill's retention system to ensure adequate retention of the ASA in the handsheets. Handsheets were produced and then the paper samples were conditioned for at least one day at 23° C. and 50% relative humidity. This follows the TAPPI T 402 om-93 Standard Conditioning and Testing Atmospheres for Paper, Board, Pulp, Handsheet, and Related Products method.

### Evaluation of Handsheets

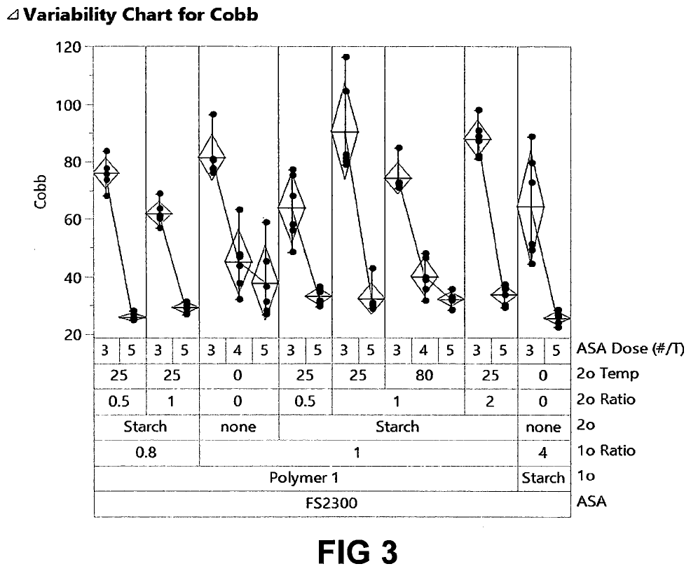

Cobb testing was performed to determine the mass of water absorbed by the surface of the sized handsheets, in g/m² (gsm) over an amount of time. Lower mass of absorbed water indicates better water resistance. For the handsheet study, Cobb testing was performed using 23° C. deionized water with an elapsed time of 2 minutes. Handsheet preparation conditions (ASA dosage in lbs/ton, ratios of primary and secondary agents to ASA, and temperature) and Cobb results are shown in FIG. 3.

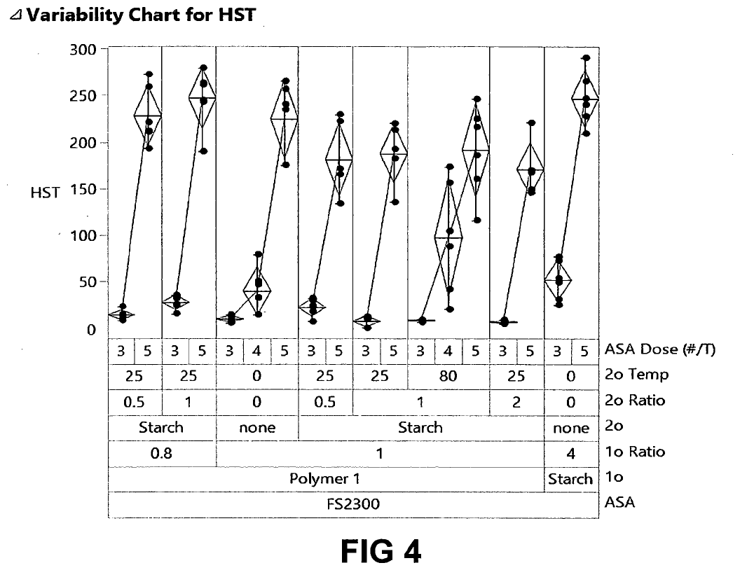

Hercules size testing (HST) was performed to measure the time required for ink to penetrate the handsheets. Longer times indicate better ink resistance. For the present handsheet study, HST testing was performed using 80% reflectance and 1% formic acid ink. Handsheet preparation conditions (ASA dosage in lbs/ton, ratios of primary and secondary agents to ASA, and temperature) and HST results are shown in FIG. 4.

Cobb results indicate good sizing performance of the inventive dual emulsification ASA samples made with cationic polymer as primary emulsifier (Polymer 1) and starch as the secondary starch emulsifier as compared to the starch only controls and Polymer 1 plus only controls. A tight grouping of Cobb values means the sizing is dispersed evenly throughout the sheet, as opposed to uneven distribution between top and bottom side of the sheet.

Little variability in Cobb values was observed for handsheets made with 5 #/ton of ASA. However, a large variability was seen at ASA dosing of 3 #/ton, with the inventive dual emulsified ASA providing the best cobb values (1° ratio polymer: ASA of 0.8:1 and 2° ratio starch: ASA of 1:1). This sample provided the lowest Cobb values with the tightest data grouping, indicating better water resistance and better sizing coverage at the lower ASA dosage (3 #/ton) than the starch control and polymer control.

Little variability in HST values was observed for handsheets made with 5 #/ton of ASA. However, a large variability was seen at ASA dosing of 3 #/ton, with the inventive dual emulsified ASA providing the best HST values (1° ratio polymer: ASA of 0.8:1 and 2° ratio starch: ASA of 1:1). This sample provided the highest HST values with the tightest data grouping, indicating better ink resistance and better sizing coverage at lower ASA dosage (3 #/ton) than the starch control and polymer control.

These results provide proof of concept that the inventive dual emulsification method can be used to prepare dual emulsified ASA sizing emulsions with enhanced sizing properties for paper products, while using less starch compared to conventional natural polymer ASA emulsification methods. These results also provide proof of concept that the inventive dual emulsification ASA samples can be effectively used as sizing to enhance the water and ink resistance of handsheets.

### Example 3: Evaluation of Dual Emulsified ASA Sizing Emulsions for Sizing of High Ash Furnish

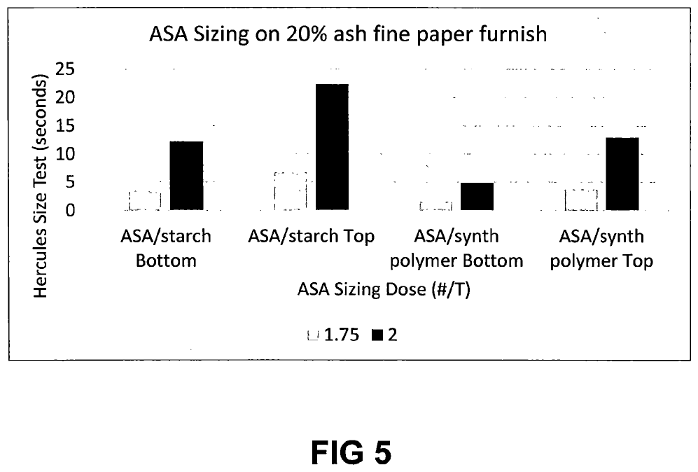

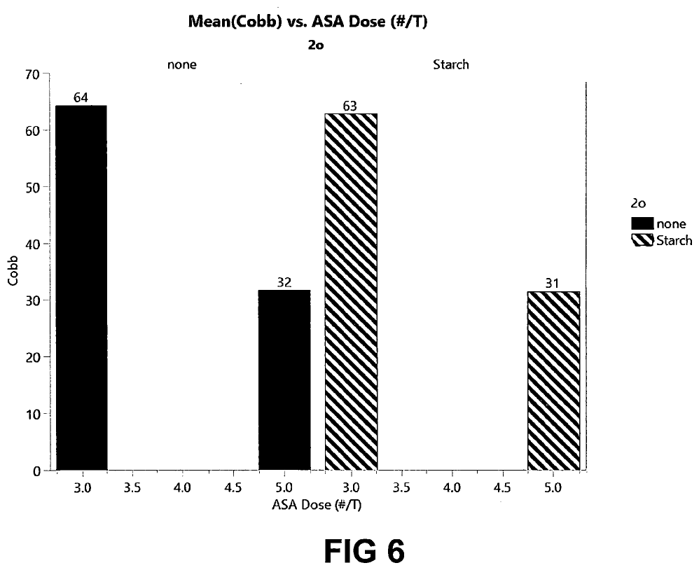

Control ASA sizing emulsions were prepared using starch only and polymer only according to Example 1. These ASA sizing emulsions were used to produce handsheets from high ash furnish (20% ash), which were evaluated for water resistance (Cobb test) and ink resistance (HST) according to Example 2. HST results of starch emulsified ASA compared to a synthetic polymer-emulsified ASA are shown in FIG. 5. Cobb results of the inventive dual emulsified ASA compared to starch emulsified ASA are shown in FIG. 6.

Ash typically refers to calcium carbonate, TiO₂, kaolin clay, silicates, and other carbonate and kaolin-based pigments. High ash furnish is typically used for producing alkaline printing and writing grade paper.

The effectiveness of modified natural polymer (cationic starch) used at high dosage as an emulsification agent is well documented for ASA sizing applications of furnish containing significant ash content (up to 35% ash). When ash is present, the sizing typically binds quickly to the ash surface and if that ash-sizing mixture is not retained in the paper, then the size is lost. Therefore, for alkaline printing and writing grade paper and board, including packaging materials, it is critical that ASA sizing emulsions be effectively retained in the paper and not lost with the ash.

FIG. 5 illustrates the effectiveness of a starch emulsified ASA compared to a synthetic polymer-emulsified ASA in a fine paper furnish containing 20% ash content. The deficiency of synthetic polymer only to provide water resistance, when used as emulsifying agents for ASA sizing emulsions for sizing of high ash paper furnish is apparent.

FIG. 6 shows an exemplary bar graph of Cobb values indicating similar sizing performance for ASA emulsions prepared using the inventive dual emulsification method (red bars) compared to starch only (blue bars). FIG. 6 illustrates that the inventive dual emulsification for ASA sizing, using synthetic polymer in the primary emulsification followed by a low dose starch application of cationic starch for secondary emulsification allows for a significant reduction in starch use without loss of sizing response.

These results provide further proof of concept that the inventive dual emulsification method can be used as sizing agents to achieve equivalent or better sizing performance than high dose starch, while significantly reducing the amount of total starch used.

### Example 4: Extended Stability of Dual Emulsified ASA Sizing Emulsions

Dual emulsified ASA sizing emulsions were prepared according to Example 1 and held for 48 hours for observation and analysis by particle size determination and viscosity measurement. Samples were stored in glass jars at room temperatures (20° C.) before being analyzed. Stability may be assessed based a median particle size or the particle size distribution of the emulsion. Specifically, for median particle size, the emulsion may be considered stable when it maintains a median particle size less than a specified value for a given period of time after emulsification. For particle size distribution, the emulsion may be considered stable when at least 95% of particles size are less than a specified value for a given period of time after emulsification. The specified value of median particle size or particle size may be [e.g., ranges between 0.5 microns and 3 microns]. The given period of time may be [e.g., ranges between 1 minute and 48 hours]. For example, in a laboratory setting an emulsion may be considered stable when the median particle size or at least 95% of particles have a particle size less than 3 microns after laboratory emulsification process is completed. In an industrial setting, emulsion may be stable when the median particle size or at least 95% of particles have a particle size less than 2 microns after emulsification process is completed. Typically, emulsions are used in a papermaking process from 1 to 10 minutes, 10 minutes to 1 hour, or 1 to 4 hours after emulsification is completed.

Extended stability testing was performed to determine the extended stability of the inventive dual emulsified ASA sizing emulsions compared to control ASA emulsions prepared with conventional starch emulsifiers. Results showing particle size distribution and viscosity measurements over time to reflect emulsion stability are shown in Table 2.

These extended stability results provide further proof of concept that the inventive dual emulsification method can be used to form very stable ASA sizing emulsions that may be temporarily stored on site or off site in a storage facility or holding tank up to 48 h for later use. These results are especially beneficial for recycled board applications.

TABLE 2
particle size and viscosity stability of ASA emulsions prepared by the inventive dual emulsification technique.

| | Primary | | Secondary | | | | | | | | | | | | |
|---|---|---|---|---|---|---|---|---|---|---|---|---|---|---|---|
| | Emulsifier | | Emulsifier | | | | | | | | | | | | |
| Primary | Ratio (to | Secondary | Ratio (to | Median particle size (μm) | | | | 95% particles < (μm) | | | | Viscosity (cP) | | | |
| Emulsifier | ASA) | Emulsifier | ASA) | Initial | 2 h | 24 h | 48 h | Initial | 2 h | 24 h | 48 h | Initial | 2 h | 24 h | 48 h |
| Starch | 4 | none | 0 | n/a | 0.816 | 2.159 | Gelled | n/a | 1.724 | 21.984 | n/a | n/a | gelled | 3564 | n/a |
| Polymer 1 | 0.8 | none | 0 | n/a | 0.921 | 1.145 | 2.44 | n/a | 1.882 | 2.66 | 8.126 | n/a | 4 | 40.5 | 33.6 |
| Polymer 1 | 0.8 | Polymer 1 | 0.5 | 0.975 | 0.901 | 1.046 | 1.699 | 2.228 | 1.953 | 2.433 | 5.574 | 15.9 | 40.5 | 44 | 45.6 |
| Polymer 1 | 0.8 | Starch | 0.5 | 0.834 | 0.861 | 1.293 | 6.902 | 1.678 | 1.456 | 3.545 | 18.101 | 41.1 | 7 | 57 | 69.6 |
| Polymer 1 | 0.8 | Starch | 1 | 0.884 | 0.921 | 1.302 | 3.986 | 1.867 | 1.928 | 3.541 | 14.542 | 41.7 | 96.5 | 297.5 | 346.8 |

What is claimed is:

1. A method for preparation of a stable alkenyl succinic anhydride (ASA) sizing emulsion which is suitable for use in manufacturing of paper and board, the method comprising:
(a) obtaining or producing an alkenyl succinic anhydride (ASA) sizing agent;
(b) combining said ASA sizing agent with a primary emulsifying agent and emulsifying to form a primary emulsion; and
(c) after step (b) adding a secondary emulsifying agent and emulsifying to form said ASA sizing emulsion, and
(d) optionally, after steps (a) to (c) adding the resultant stable ASA sizing emulsion to a papermaking furnish, pulp, or fiber stock, optionally a high ash furnish.

2. The method of claim 1, wherein the method further comprises, after step (c):
(a) adding said ASA sizing emulsion to said papermaking furnish, pulp, or fiber stock; or
(b) adding said ASA sizing emulsion to said high ash furnish comprising ash selected from the group consisting of calcium carbonate, TiO₂, kaolin clay, silicates, carbonate based pigments, kaolin based pigments, or any combination of the foregoing, wherein said high ash furnish comprises a percent ash content of 1-35%, 2-30%, 5-25%, or 10-20% by mass, preferably 5%-25% ash by mass.

3. The method of claim 1 or 2, wherein said ASA sizing agent comprises:
(a) an ASA solid, an ASA waxy solid, an ASA waxy liquid, an ASA liquid, or a mixture thereof; and
(b) a single ASA sizing agent or a mixture of ASA sizing agent molecules and/or isomers.

4. The method of any one of claims 1-3, wherein (i) said primary emulsifying agent comprises an aqueous polymer solution comprising one or more cationic polymers and water; and (ii) said secondary emulsifying agent comprises one or more cationic starches.

5. The method of any one of claims 1-4, wherein said aqueous polymer solution comprises a percent solids by weight of said one or more cationic polymers ranging from 1-70%, 2-50%, or 5-30%.

6. The method of any one of claims 1-5, wherein said one or more cationic polymers comprise:
(a) one or more synthetic copolymers, terpolymers, or tetrapolymers comprising acrylamide and one or more cationic monomers selected from the group consisting of
(i) diallyldialkylammonium halides, including but not limited to, diallyldimethylammonium chloride (“DADMAC”) and diallyldiethylammonium chloride;
(ii) N,N-dialkylaminoalkyl acrylates, N,N-dialkylaminoalkyl (meth)acrylates, and acid addition salts and/or quaternary ammonium salts thereof, including but not limited to, acryloyloxyethyltrimethyl ammonium chloride (“AETAC”), methacryloyloxyethyltrimethylammonium chloride (“MAETAC”), dimethylaminoethyl acrylate (“DMAEA”) and acid addition salts thereof, dimethylaminoethyl methacrylate (“DMAEMA”) and acid addition salts thereof, dimethylaminoethyl acrylate methyl sulfate quaternary salt, dimethylaminoethyl acrylate benzyl chloride quaternary salt, dimethylaminoethyl acrylate sulfuric acid salt, dimethylaminoethyl acrylate hydrochloric acid salt, diethylaminoethyl acrylate, methyl chloride quaternary salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dimethylaminoethyl methacryloyl hydrochloric acid salt;
(iii) N,N-dialkylaminoalkylacrylamides and N,N-dialkylaminoalkyl (meth)acrylamides and acid addition salts or quaternary ammonium salts thereof, including but not limited to, acrylamidopropyltrimethylammonium chloride (“APTAC”), methacrylamidopropyltrimethylammonium chloride (“MAPTAC”), dimethylaminopropyl acrylamide methyl sulfate quaternary salt, dimethylaminopropyl acrylamide sulfuric acid salt, dimethylaminopropyl acrylamide hydrochloric acid salt, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate; or
(iv) any combination of (i)-(iii);
(b) said one or more synthetic copolymers, terpolymers, or tetrapolymers of (a), optionally containing
(i) one or more additional non-ionic monomers selected from the group consisting of methacrylamide; N-alkylacrylamides, including but not limited to, N-methylacrylamide, N-ethylacrylamide, N-propylacrylamide, and N-butylacrylamide; N,N-dialkylacrylamides, including, but not limited to, N,N-dimethylacrylamide and N,N-diethylacrylamide; N-alkyl methacrylamides; alkyl acrylates; hydroxyalkyl acrylates and methacrylates, including but not limited to, hydroxymethyl acrylate, 2-hydroxyethyl acrylate, 3-hydroxypropyl acrylate, 4-hydroxybutyl acrylate, hydroxymethyl methacrylate, 2-hydroxyethyl methacrylate, 3-hydroxypropyl methacrylate, and 4-hydroxybutyl methacrylate; dihydroxyalkyl acrylates and methacrylates, including but not limited to, 2,3-dihydroxypropyl acrylate, 3,4-dihydroxybutyl acrylate, 2,3-dihydroxypropyl methacrylate (DHPMA), and 3,4-dihydroxybutyl methacrylate; alkyl acrylates, including but not limited to, methyl methacrylate; acrylonitrile; N-vinylmethylacetamide, N-vinylmethylformamide; N-vinyl acetate, glyoxalated acrylamides, and vinyl pyrrolidone;
(ii) one or more additional anionic monomers selected from the group consisting of acrylic acid, methacrylic acid, sulfonic acids, phosphonic acids, and alkali metal salts, alkaline earth metal salts, and ammonium salts thereof, including but not limited to, acrylic acid, methacrylic acid, maleic acid, itaconic acid, vinyl sulfonic acid, 2-acrylamido-2-methylpropane sulfonic acid (AMPS), acrylamido methanesulfonic acid, acrylamido ethanesulfonic acid, 2-hydroxy-3-acrylamide propane sulfonic acid, styrene sulfonic acid, and vinyl phosphonic acid; or
(iii) any combination of (i)-(ii);
(c) one or more cationic glyoxalated polyacrylamide (GPAM) polymers obtainable by reaction of glyoxal with said one or more synthetic copolymers, terpolymers, or tetrapolymers of (a), said one or more synthetic copolymers, terpolymers, or tetrapolymers of (b), or a combination thereof;
(d) one or more semisynthetic polymers comprising said one or more synthetic copolymers, terpolymers, or tetrapolymers of (a) or (b) optionally grafted onto one or more natural polymers, including but not limited to, starch, chitin, chitosan, and natural polysaccharides; or
(e) any combination of (a)-(d),
and wherein said one or more cationic polymers has a weight average molecular weight ranging from 10,000-3,000,000 Da, 10,000-2,000,000 Da, 10,000-1,000,000 Da, 10,000-500,000 Da, 10,000-200,000 Da, 10,000-100,000 Da, or 10,000-50,000 Da.

7. The method of any one of claims 1-6, wherein said one or more cationic starches:
(a) comprise one or more cationic modified or unmodified starches selected from the group of starches consisting of corn starch, waxy maize starch, potato starch, tapioca starch, wheat starch, rice starch, barley starch, pea starch, sweet potato starch, and any combination thereof; and
(b) have a percent nitrogen (% N) content ranging from 0.2-2%, 0.2-1.75%, 0.2-1.5%, 0.2-1.25%, 0.2-1%, or 0.25-0.45% by mass, preferably 0.35-1.45% by mass.

8. The method of any one of claims 1-7, wherein said one or more cationic starches is formulated prior to addition to said ASA sizing agent by a method comprising:
(a) dissolving a dry cationic starch in water; cooking by a method, including but not limited to, jet cooking, steam cooking, or pot cooking; and cooling to a temperature ranging from 20-80° C., 20-60° C., 20-40° C., or 20-25° C., preferably 20-40° C. to obtain a cooked starch solution having percent solids ranging from 1-10%, 2-8%, or 3-6% by mass; or
(b) obtaining a pre-gelatinized cationic starch having percent solids ranging from 20% to 40% by mass and diluting with water to obtain a pre-gelatinized starch solution having a percent solids ranging from 1-10%, 2-8%, or 3-6% by mass.

9. The method of any one of claims 1-8, wherein (i) said one or more cationic polymers are selected from the group consisting of acrylamide/[2-(methyl-acryloyloxy)ethyl]trimethylammonium chloride copolymer (AMD/MAETAC), acrylamide/[2-(methylacryloyloxy)ethyl]trimethylammonium chloride/2-hydroxyethy methacrylate (AMD/MAETAC/HEMA) terpolymers, acrylamide/[2-(methylacryloyloxy)ethyl]trimethylammonium chloride/2-hydroxyethy methacrylate/acrylic acid (AMD/MAETAC/HEMA/AA) tetrapolymers, and acrylamide/[2-(methylacryloyloxy)ethyl]trimethylammonium chloride/2,3-dihydroxypropyl methacrylate (AMD/MAETAC/DHPMA) terpolymer and (ii) said one or more cationic starches comprises corn starch, waxy maize starch, potato starch, tapioca starch, wheat starch, or pea starch.

10. The method of any one of claims 1-9, wherein the method comprises one or more of the following:
(a) adding said primary emulsifying agent to said alkenyl succinic anhydride (ASA) sizing agent to a obtain a ratio of grams of active cationic polymer to grams of ASA of 0.05:1 to 0.6:1, 0.1:1 to 0.5:1, 0.15:1 to 0.4:1, or 0.2:1 to 0.25:1; and
(b) adding said secondary emulsifying agent to said primary emulsion to obtain a ratio by mass of dry starch to ASA of 0.25:1 to 2:1, 0.3:1 to 1.6:1, 0.4:1 to 1.2:1, or 0.5:1 to 1:1.

11. The method of any one of claims 1-10, wherein the method comprises:
(a) adding said primary emulsifying agent to said ASA sizing agent at ambient temperature and emulsifying by agitating with sufficient energy to achieve a median ASA particle size ranging from 0.5-3 μm, 0.5-2 μm, or 0.5-1 μm in diameter; and/or
(b) adding said secondary emulsifying agent to said primary emulsion at a temperature ranging from 20-80° C., 20-60° C., 20-40° C., or 20-25° C., preferably 20-40° C. and emulsifying by agitating with sufficient energy to achieve a median ASA particle size ranging from 0.5-3 μm, 0.5-2 μm, or 0.5-1 μm in diameter.

12. The method of any one of claims 1-11, wherein said ASA sizing emulsion, in final form:
(a) comprises a median particle size ranging from 0.5-1 μm, 0.6-0.9 μm, or 0.7-0.8 μm in diameter;
(b) comprises a viscosity ranging from 10-100 cP, 20-90 cP, 30-80 cP, 40-70 cP, or 50-60 cP, when measured by a Brookfield viscometer with spindle 62 at 60 rpm and 20° C.;
(c) has a stability of 1-4 min, 1-10 min, 1 min-1 h, 1-6 h, 1-12 h, 1-24 h, or 1-48 h, wherein said stability is determined by said ASA sizing emulsion retaining
(i) a median particle size of 0.5-3 μm, 0.5-2 μm, 0.5-1 μm, 0.6-0.9 μm, or 0.7-0.8 μm in diameter, preferably less than 1 μm;
(ii) a viscosity ranging from 10-100 cP, 20-90 cP, 30-80 cP, 40-70 cP, or 50-60 cP, preferably less than 100 cP, when measured by a Brookfield viscometer with spindle 62 at 60 rpm and 20° C.;
(d) is immediately added to a papermaking furnish, pulp, or fiber stock, optionally a high ash furnish or is stored in a storage tank or holding facility for a storage time of 1-4 min, 1-10 min, 1 min-1 h, 1-6 h, 1-12 h, 1-24 h, or 1-48 h prior to addition of said ASA sizing emulsion to a papermaking furnish, pulp, or fiber stock, optionally a high ash furnish;
(e) comprises a decreased final ratio by mass of dry starch to ASA compared to an ASA sizing emulsion prepared by a single or dual emulsification method using one or more emulsifying agents comprising one or more cationic starches; or
(f) any combination of (a)-(e).

13. The method of any one of claims 1-12, wherein when said stable alkenyl succinic anhydride (ASA) sizing emulsion is used as a sizing agent during the manufacture of paper or board it results in a sheet-like product selected from the group consisting of a high ash paper or board, a printing or writing grade paper or board, an alkaline printing or writing grade paper or board, a bleached paper or board, a packaging grade paper or board, and a partially recycled or 100% recycled paper or board, wherein said sheet like product comprises optimal sizing performance as measured by industry standardized testing, including, but not limited to, HST, Cobb, water drop testing, contact angle, edge-wick or water penetration or combinations thereof, wherein said optimal sizing performance is determined in relation to an equivalent sheet-like product comprising an ASA sizing emulsion prepared by a single or dual emulsification method using one or more emulsifying agents comprising one or more cationic starches.

14. A dual emulsification method for preparation of an alkenyl succinic anhydride (ASA) sizing emulsion for use in manufacturing of paper and board, the method comprising:
(a) obtaining or producing an alkenyl succinic anhydride (ASA) sizing agent;
(b) combining said ASA sizing agent with a primary emulsifying agent and emulsifying at ambient temperature and agitating with sufficient energy to achieve a median ASA particle size ranging from 0.5-3 μm, 0.5-2 μm, or 0.5-1 μm in diameter thereby forming a primary emulsion; and
(c) after step (b), adding a secondary emulsifying agent and emulsifying at a temperature ranging from 20-80° C., 20-60° C., 20-40° C., or 20-25° C., preferably 20-40° C. and agitating with sufficient energy to achieve a median ASA particle size ranging from 0.5-3 μm, 0.5-2 μm, or 0.5-1 μm in diameter thereby forming said ASA sizing emulsion, and
(d) optionally after step (c), adding said ASA sizing emulsion to a high ash papermaking furnish,
wherein
(i) said primary emulsifying agent comprises an aqueous polymer solution comprising cationic copolymers of acrylamide selected from the group consisting of acrylamide/[2-(methyl-acryloyloxy)ethyl]trimethylammonium chloride copolymer (AMD/MAETAC), acrylamide/[2-(methylacryloyloxy)ethyl]trimethylammonium chloride/2-hydroxyethy methacrylate (AMD/MAETAC/HEMA) terpolymers, acrylamide/[2-(methylacryloyloxy)ethyl]trimethylammonium chloride/2-hydroxyethy methacrylate/acrylic acid (AMD/MAETAC/HEMA/AA) tetrapolymers, and acrylamide/[2-(methylacryloyloxy)ethyl]trimethylammonium chloride/2,3-dihydroxypropyl methacrylate (AMD/MAETAC/DHPMA) terpolymer;
(ii) said secondary emulsifying agent comprises one or more cationic modified or unmodified starches; selected from the group of starches consisting of corn starch, waxy maize starch, potato starch, tapioca starch, wheat starch, pea starch, and a mixture thereof;
(iii) said high ash papermaking furnish comprises ash selected from the group consisting of calcium carbonate, TiO2, kaolin clay, silicates, carbonate-based pigments, kaolin based pigments, or any combination of the foregoing;
(iv) said high ash papermaking furnish comprises a percent ash content of 1-35%, 2-30%, 5-25%, or 10-20% by mass, preferably 5%-25% by mass;
(v) said primary emulsifying agent is added to said alkenyl succinic anhydride (ASA) sizing agent to a obtain a ratio of grams of active cationic polymer to grams of ASA of 0.05:1 to 0.6:1, 0.1:1 to 0.5:1, 0.15:1 to 0.4:1, or 0.2:1 to 0.25:1; and
(vi) said secondary emulsifying agent is added to said primary emulsion to obtain a ratio by mass of dry starch to ASA of 0.25:1 to 2:1, 0.3:1 to 1.6:1, 0.4:1 to 1.2:1, or 0.5:1 to 1:1.

15. An ASA sizing emulsion composition or a papermaking furnish, pulp, or fiber stock, optionally a high ash furnish, comprising said ASA sizing emulsion composition, obtainable by a method according to any of the foregoing claims.

16. A process for the production of paper or board, the process comprising obtaining a high ash furnish, comprising wood pulp, optionally fiber stock comprising a high content of recycled fibers and/or mill broke fibers, optionally a thick fiber stock, optionally a bleached fiber stock, optionally containing process water from pulp, paper, or board production and treating said fiber stock at the wet end of a paper machine with an ASA sizing emulsion according to any of the foregoing claims, wherein:
(a) said high ash furnish comprises ash selected from the group consisting of calcium carbonate, TiO₂, kaolin clay, silicates, carbonate-based pigments, kaolin based pigments, or any combination of the foregoing; and
(b) said high ash furnish comprises a percent ash content of 1-35%, 2-30%, 5-25%, or 10-20% by mass, preferably 5%-25% ash by mass.
